(19) United States
(12) Patent Application Publication
(10) Pub. No.: US 2019/0270387 A1
(43) Pub. Date: Sep. 5, 2019

(54) VEHICLE ON-BOARD MULTI-PHASE POWER GENERATION

(71) Applicant: Ford Global Technologies, LLC, Dearborn, MI (US)

(72) Inventors: Aed M. Dudar, Canton, MI (US); Thomas G. Leone, Ypsilanti, MI (US); Kenneth James Miller, Canton, MI (US)

(21) Appl. No.: 15/912,013

(22) Filed: Mar. 5, 2018

(51) Int. Cl. B60L 11/08; H02M 1/10; B60L 11/18; H02K 17/04

(52) U.S. Cl. CPC B60L 11/08; H02M 1/10; B60L 1/003; H02K 17/04; B60L 11/1812

(57) ABSTRACT

Method and apparatus are disclosed for vehicle on-board multiphase power generation. An example vehicle includes an engine and a generator electrically coupled to the engine. The example vehicle also includes a phase converter electrically coupled to an input connector and the generator and an output connector electrically coupled to the phase converter. The phase converter provides multi-phase power to the output connector using power from the generator and power from a secondary source connected to the input connector.

### TECHNICAL FIELD

The present disclosure generally relates to vehicle with integrated mobile power generators and, more specifically, vehicle on-board multiphase power generation.

### BACKGROUND

Increasingly, vehicles, especially utility vehicles (e.g., sports utility vehicles, trucks, etc.), are being manufactured with on-board generators that provide signal phase alternating current (AC) power to an externally accessible power outlets. These vehicle provide power for everyday tasks and leisure, such as for power tools, lighting, outdoor sound systems, and water pumps, etc.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are disclosed for vehicle on-board multiphase power generation. An example vehicle includes an engine and a generator electrically coupled to the engine. The example vehicle also includes a phase converter electrically coupled to an input connector and the generator and an output connector electrically coupled to the phase converter. The phase converter provides multi-phase power to the output connector using power from the generator and power from a secondary source connected to the input connector.

An method includes periodically requesting, by a server, vehicle characteristics from first vehicles and second vehicles. The example method also includes, in response to receiving a power request, selecting, by the server, one or more of the first vehicles and the second vehicles based on the vehicles characteristics and the power request, and instructing the selected ones of the first vehicles and the second vehicles to proceed to a location associated with the power request.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIGS. 1A, 1B, and 1C illustrate vehicles coupled together to provide multi-phase power according to the teachings of this disclosure.

FIGS. 2A, 2B, and 2C illustrate power outlets of the vehicles of FIGS. 1A, 1B, and 1C.

FIG. 3 illustrates a system to coordinate the vehicles of FIGS. 1A, 1B, and 1C to provide multi-phase power.

FIG. 4 illustrates an interface to coordinate the vehicles of FIGS. 1A, 1B, and 1C to provide multi-phase power.

FIG. 5 is a block diagram of electronic components of the vehicles of FIGS. 1A, 1B, and 1C.

FIG. 6 is a flowchart of a method to provide multi-phase power, which may be implemented by the electronic components of FIG. 5.

FIG. 7 is a flowchart of a method to coordinate and manage provision of multi-phase power by multiple vehicles, which may be implemented by the power management server of FIGS. 3 and 5.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Vehicles, such as trucks and sports utility vehicles, are manufactured with generators that are designed to provide single-phase alternating (AC) power to power outlets that are accessible to external machinery. These systems are sometimes referred to as “Power-to-the-Box (PttB)” systems. The generators are full sine wave inverters that convert the power generated by the engine. For a standard vehicle (e.g., a vehicle that exclusively uses a petroleum-based fuel), for example, the generator may produce 400 watts of (W) AC power at 120 volts (V) while the vehicle is in motion and 2,000 W of AC power at 120V when the vehicle is stationary. As another example, a generator of a hybrid vehicle (e.g., a vehicle with a fuel-based engine and an electric motor) may produce 2,400 W of 7,000 W of AC power a 120V regardless or whether the vehicle is stationary or mobile. This power is provided to outlets that are located in the cabin of the vehicle and/or on an external surface of the vehicle (e.g., in the bed of a truck, etc.). However, some tools and appliances require multi-phase power to operate. For example, a table saw at a construction site may require two-phase power. Additionally, in times of emergency relief (e.g., post hurricanes and/or earthquakes, etc.), a fleet of vehicles with on-board generators may be called upon to deliver diverse power voltages to different electrical equipment for rescue and relief operations.

As described below, vehicles include phase converters that electrically couple to the generating systems of other vehicles to provide multi-phase power to the outlet of the vehicle. The phase converter receives input from multiple power generating sources to produce desired multi-phase power. For example, the phase converter may receive two single-phase 120V power input and produce a two-phase power output at 240V, with each phase being 180° apart.

As used herein, vehicles with the on-board generators that include the phase converters are referred to as “primary vehicles.” As used herein, vehicles with the on-board generators that do not include the phase converters are referred to as “secondary vehicles.” Primary vehicles include power plugs that facilitate the generator systems of the secondary vehicles being electrically connected (e.g. via power cords) to the phase converter of the primary vehicle. In some examples, the primary vehicle includes a two-phase phase converter that receives as inputs the power from the generator of the primary vehicle and power from a secondary vehicle (or an external generator, or a building, etc.) to produce two-phase AC power. In some examples, the primary vehicle includes a three-phase phase converter that receives as inputs the power from the generator of the primary vehicle and power from two secondary vehicles (and/or external generators, buildings, etc.) to produce three-phase AC power. In some examples, the primary vehicle includes a phase converter (or multiple phase converters) capable of generating both two-phase power and three-phase power. In such examples, the primary vehicle includes input plugs to accept electrical connections from two external sources. In some examples, the primary vehicle includes a output plug for each phase. Alternatively, in some examples, the output plug is configured to use different configurations of pins/sockets depending on which type of power is being produced.

In first example scenario, a power tool may require two-phase power. In such a scenario, a secondary vehicle with a single-phase generator may be connected to the primary vehicle that has a single-phase generator to provide two-phase power. In a second example scenario, a power tool may require three-phase power. In such a scenario, two secondary vehicles, each with a single-phase generator, is connector to the primary vehicle that has a single phase generator to provide three-phase power. In a third example scenario, a power tool may require two-phase power. In such a scenario, a secondary vehicle with a single-phase generator may be connected to the primary vehicle that has a two-phase generator to provide three-phase power. In a fourth example scenario, a power tool may require two-phase power. In such a scenario, a wall outlet providing single-phase power may be connected to the primary vehicle that has a single-phase generator to provide two-phase power. In a fifth example scenario, a power tool may require three-phase power. In such a scenario, an external single-phase generator and a secondary vehicle with a single phase generator may connected to the primary vehicle that has a single-phase generator to produce three-phase power.

Additionally, as described below, a power management server coordinates provision of power in a geographic area based on a power requirement at a location and available sources of power (e.g., primary vehicles, secondary vehicles, external generators, buildings, etc.) near that location. For example, a hospital may need power to operate a wing after a natural disaster. The primary and secondary vehicles are communicatively coupled to the power management server via an external network (such as the Internet). From time to time, the primary and secondary vehicles send vehicle characteristics and their locations to the power management server. The vehicle characteristics includes whether it is a primary or secondary vehicle, the type of on-board generator (e.g., signal phase or two phase), the type of phase converter (for primary vehicles), and/or current fuel level, etc. Additionally, in some examples, an operator inputting the power request also indicates what other power resources are available at the location associated with the power requirement. For example, the operator may indicate that a single-phase external generator is onsite or that single-phase power from a building is available. Using the locations of the primary and secondary vehicles and their vehicle characteristics, the power management server selects one or more of the primary and secondary vehicles to proceed to the location associated with the power requirement. The power management server selects at least one primary vehicle to facilitate generation of multi-phase power. The power management server sends a notification the selected vehicle(s). In some examples, when the selected vehicles are autonomous, the power management server sends instructions to the autonomous vehicle to navigate to the location associated with the power requirement.

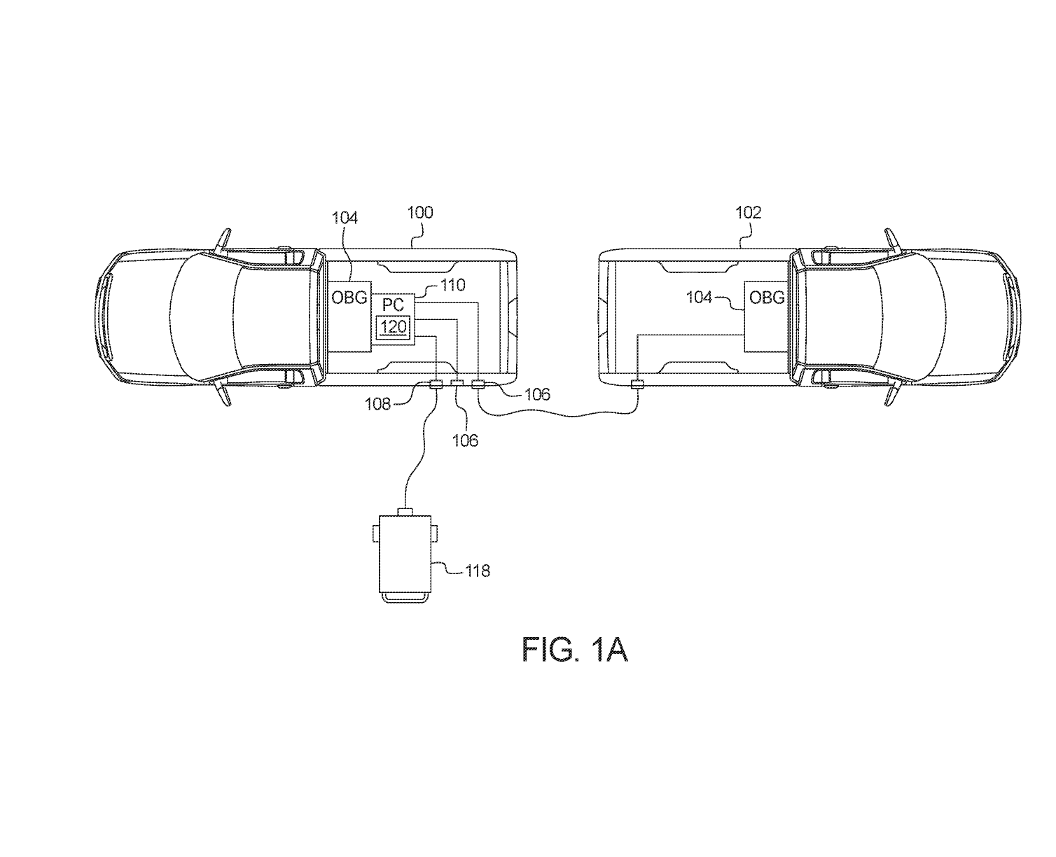

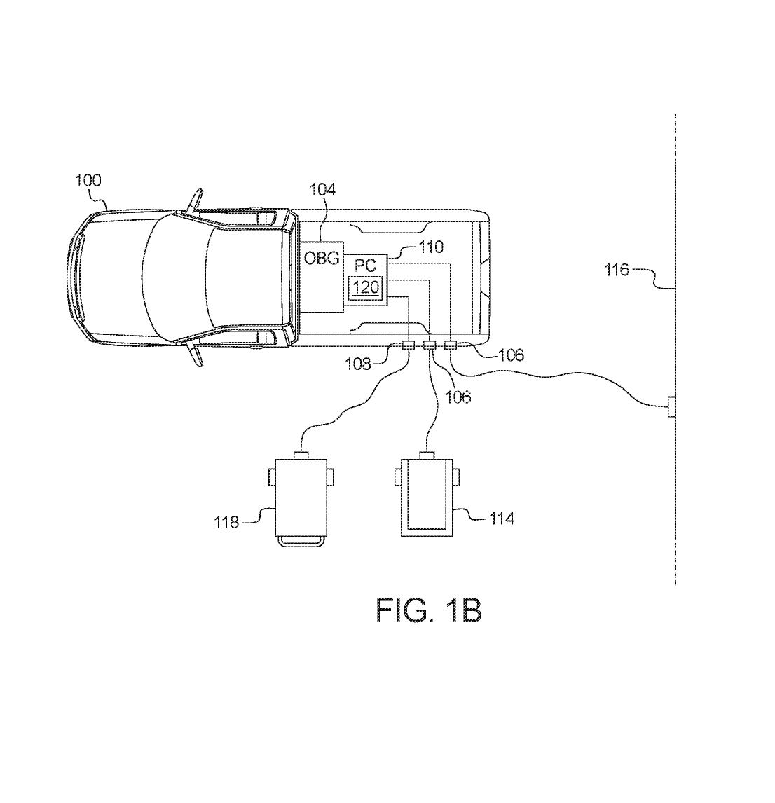

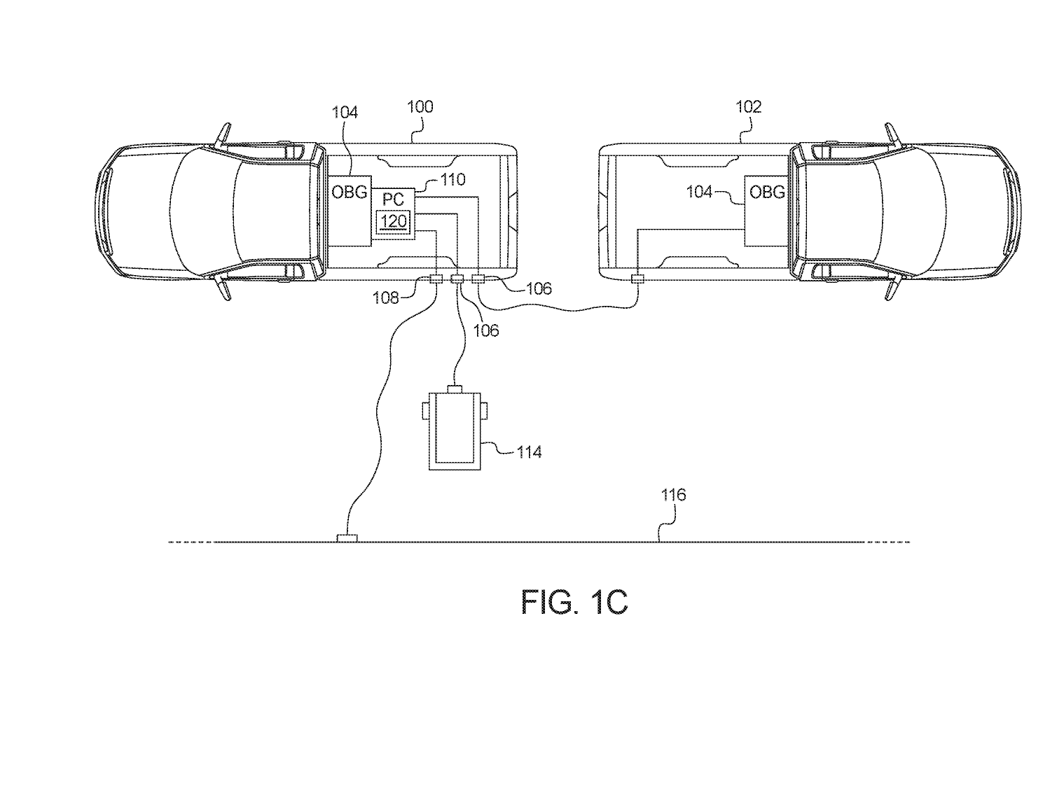

FIGS. 1A, 1B, and 1C illustrate vehicles 100 and 102 coupled together to provide multi-phase power according to the teachings of this disclosure. The vehicles 100 and 102 may be standard gasoline powered vehicles, hybrid vehicles, and/or fuel cell vehicles, etc. The vehicles 100 and 102 include parts related to mobility, such as a powertrain with an engine, an electric motor, a transmission, a suspension, a driveshaft, and/or wheels, etc. The vehicles 100 and 102 may be non-autonomous, semi-autonomous (e.g., some routine motive functions controlled by the vehicle), or autonomous (e.g., motive functions are controlled by the vehicle without direct driver input). The illustrated examples include primary vehicles 100 and secondary vehicles 102. While the primary vehicles 100 and secondary vehicles 102 are illustrated as land-based vehicles, the primary vehicles 100 and secondary vehicles 102 may be any suitable type of vehicle, such as an aircraft (e.g., a helicopter, an unmanned aerial vehicle (UAV) (sometimes referred to as a “drone”), etc.) or a watercraft. In the illustrated examples, the primary vehicle 100 includes a generator 104, one or more input connectors 106, one or more output connectors 108, and a phase converter 110. In the illustrated examples, the secondary vehicle 102 includes the generator 104 and the output connectors 108.

The generator 104 is a full sine wave inverter that converts the power generated by the engine into alternating current (AC) power suitable to be used by external sources. In some examples, the generator 104 converts the power generated by the engine into 120 volt (V) single-phase power. Alternatively, in some examples, the generator 104 converts the power generated by the engine into 240V two-phase power, where the phases are 180° apart. The generator 104 may be located in the engine compartment of the vehicle 100 and 102 or any other suitable location, such as below floor of a bed of a truck.

The input connector(s) 106 is/are configured to receive power cords 112 from the secondary vehicle(s) 102, external generator(s) 114, and/or buildings 116. In some examples, the input connector(s) 106 include pins. Alternatively, in some examples, the input connector(s) 106 include sockets. The input connector(s) 106 are located on a surface of the primary vehicle 100. In some examples, the input connector(s) 106 is/are located in a cargo bed of the primary vehicle 100. In some examples, the input connector(s) 106 is/are located on an interior panel or an exterior panel of the primary vehicle 100. The output connector(s) 108 is/are configured to receive power cords 112 that couple to devices that require power, such as power tools 118 and/or building power systems, etc. In some examples, the output connector(s) 106 include pins. Alternatively, in some examples, the output connector(s) 106 include sockets. The configuration of the pins/sockets is determined by the type of power being delivered to the output connector 108. In some examples, the output connector(s) 108 is/are located in a cargo bed of the primary vehicle 100. In some examples, the output connector(s) 108 is/are located on an interior panel or an exterior panel of the primary vehicle 100.

The phase converter 110 receives input of multiple AC power sources, such as the generator 104 of the primary vehicle 100, a secondary vehicle 102, an external generator 114, and/or a building 116. The phase converter 110 receives outputs power with a number of phases greater than any one of the input sources. For example, when receiving single-phase power from the generator 104 of the primary vehicle 100 and single phase power from the secondary vehicle 102, the phase converter 110 may output two-phase power, with each phase separated by 90°. In some examples, the phase converter 110 is a two-phase converter that outputs two-phase power. In some examples, the phase converter 110 is a three-phase converter that outputs three-phase power. In some examples, the phase converter 110 is a modular phase converter that includes circuitry to either generate two-phase power or three phase power depending on the sources connected to the input connectors 106. In the illustrated example, the phase converter 110 includes a phase selector 120.

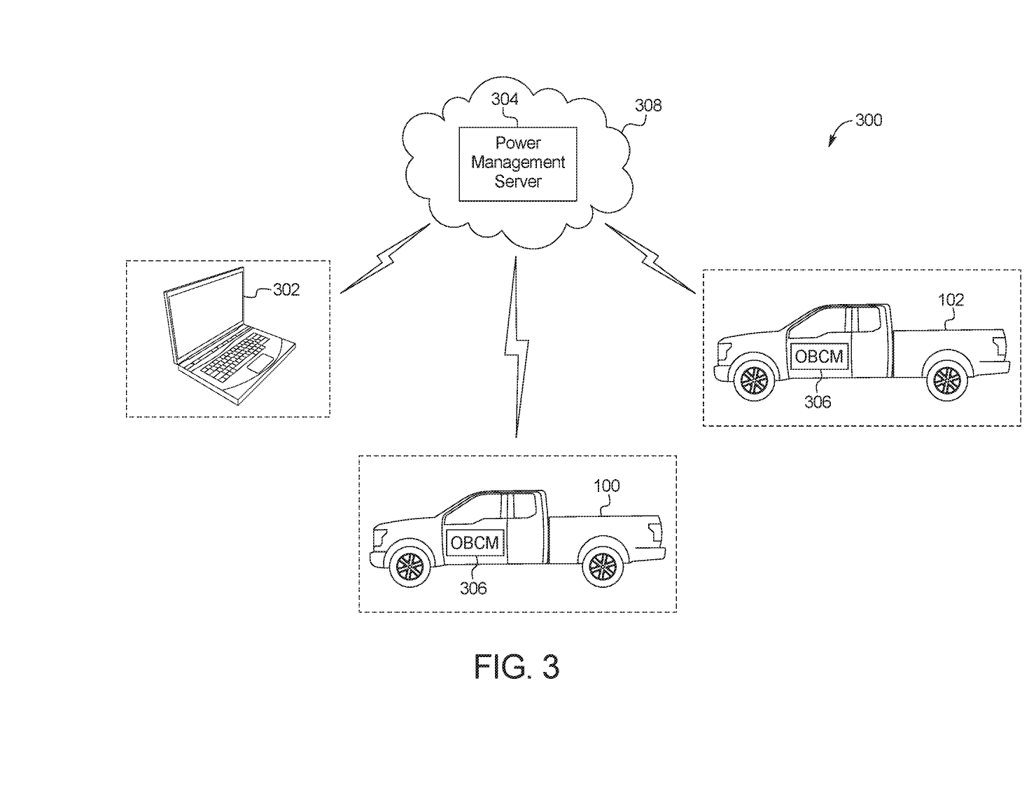

The phase selector 120 controls the phase converter 110 to either produce two-phase power or three-phase power based on detecting the input or based on a user selection (e.g., via a center console display, etc.). For example, when the phase selector 120 detects power sources connected to two of the input connectors 106, the phase selector 120 configure the phase converter to generate three-phase power. In some examples, the phase selector 120 controls the type of power generated by the phase converter 110 based on the instructions received from a power management server (e.g., the power management server 304 of FIG. 3 below). In some examples, when the primary vehicle 100 includes a phase converter 110 that generates either two-phase or three-phase power and one output connector 108, the phase selector 120 configures the pins/sockets of the output connector 108 to be configured for the particular type of power being generated.

FIGS. 1A, 1B, and 1C illustrate exemplary scenarios for the primary vehicle 100. FIG. 1A illustrates a primary vehicle 100 and a secondary vehicle 102 at a construction site. In the illustrated example, the secondary vehicle 102 is connected to one of the input connectors 106 of the primary vehicle 100 via a power cord 112 and the output connector 108 of the primary vehicle 100 is connected to a power tool 118. FIG. 1B illustrates a primary vehicle 100 on a construction site. In the illustrated example, a building 116 and an external generator 114 are connected to input connectors 106 of the primary vehicle 100 via power cords 112, and the output connector 108 of the primary vehicle 100 is connected to a power tool 118. In the illustrated example of FIG. 1C, a primary vehicle 100 and a secondary vehicle 102 at a building, such as a hospital. In the illustrated example, the secondary vehicle 102 and an external generator 114 are connected to input connectors 106 of the primary vehicle 100 via power cords 112, and the output connector 108 of the primary vehicle 100 is connected to an input of a power system of a building 116.

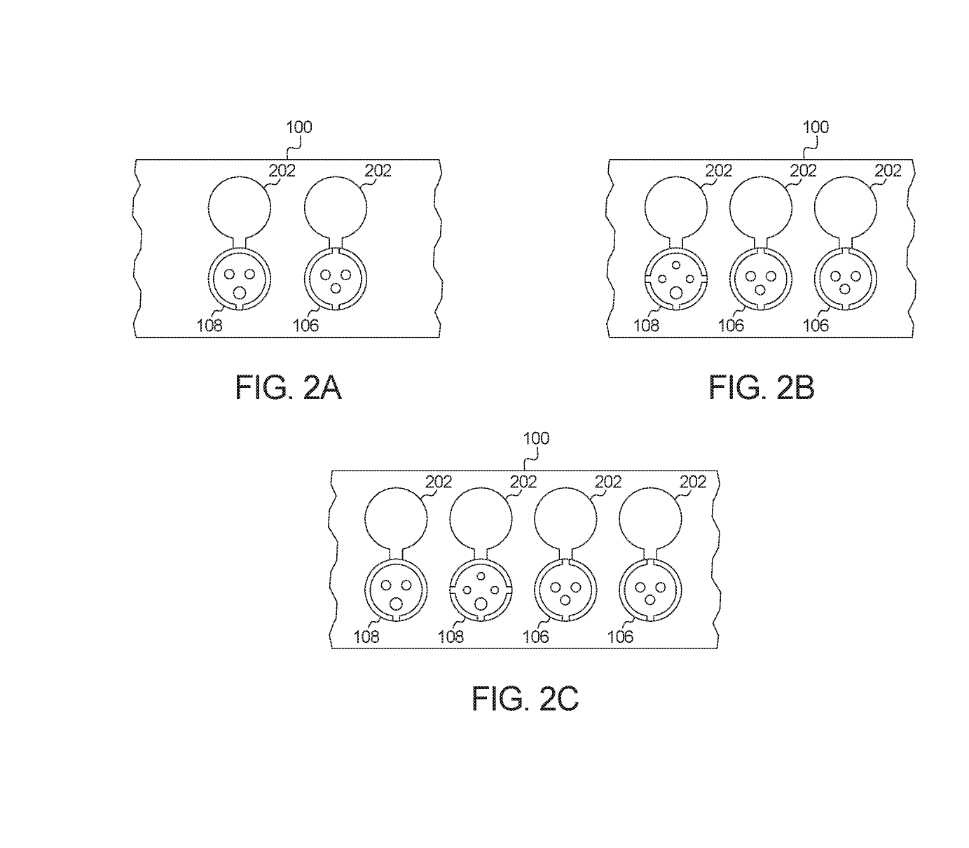

FIGS. 2A, 2B, and 2C illustrate different configurations (e.g., number of pins, size of connector, keying of connector, etc.) of the input connectors 106 and the output connectors 108 of FIGS. 1A, 1B, and 1C. The configurations of the input connector 106 and the output connectors 108 illustrated in FIGS. 2A, 2B, and 2C are exemplary. The positioning and shape of the pins/sockets, the shape of the connector housing and/or the keying may be any suitable design (e.g., connectors that are compliant with International Electrotechnical Commission (IEC) 60309, MIL-DTL-5015/38999, or National Electrical Manufacturers Association (NEMA) L5-L23, etc.). As illustrated in FIGS. 2A, 2B, and 2C, the pins and/or sockets of the input connectors 106 and the output connectors 108 may differ based on the type of power being provided to/from the particular input connector 106 or the output connector 108. In the illustrate examples, the input connectors 106 and the output connectors 108 have corresponding covers 202 that protect the connector from the damage or contamination while not in use. For example, the cover may include a gasket that, when the cover is shut, prevents dirt and/or liquids from entering a cavity of the connector. FIG. 2A illustrates an example primary vehicle 100 with one input connector 106 to receive single-phase power and one output connector 108 to provide two-phase power. FIG. 2B illustrates an example primary vehicle 100 with two input connectors 106 to receive single-phase power and one output connector 108 to provide three-phase power. FIG. 2C illustrates an example primary vehicle 100 with two input connectors 106 to receive single-phase power and one output connector 108 to provide three-phase power and one output connector 108 to provide two-phase power.

FIG. 3 illustrates a system 300 to coordinate the vehicles 100 and 102 of FIGS. 1A, 1B, and 1C to provide multi-phase power. In the illustrated example, the system 300 includes the primary vehicle(s) 100, the secondary vehicle(s) 102, a computing device 302, and a power management server 304.

In the illustrated example, the primary vehicle(s) 100 and the secondary vehicle(s) 102 also include an on-board communication module (OBCM) 306. The on-board communication module 306 includes wired or wireless network interfaces to enable communication with external networks (e.g., the external network 308). The on-board communication module 306 also includes hardware (e.g., processors, memory, storage, antenna, etc.) and software to control the wired or wireless network interfaces. In the illustrated example, the on-board communication module 306 includes one or more communication controllers for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); local area wireless network (including IEEE 802.11 a/b/g/n/ac or others), dedicated short range communication (DSRC), and Wireless Gigabit (IEEE 802.11ad), etc.). In some examples, the on-board communication module 306 includes a wired or wireless interface (e.g., an auxiliary port, a Universal Serial Bus (USB) port, a Bluetooth® wireless node, etc.) to communicatively couple with a mobile device (e.g., a smart phone, a smart watch, a tablet, etc.). In such examples, the vehicle 100 and 102 may communicated with the external network 308 via the coupled mobile device. The external network(s) 308 may be a public network, such as the Internet; a private network, such as an intranet; or combinations thereof, and may utilize a variety of networking protocols now available or later developed including, but not limited to, TCP/IP-based networking protocols.

The computing device 302 (e.g., a laptop computer, a desktop computer, a smart phone, a smart watch, a tablet, a workstation, etc.) communicatively coupled to the external network 308 to communicate with the power management server 304. An operator interacts with the computing device 302 (e.g., via an application, via a website, etc.) to input power requirements to the power management server 304. The power requirements include a location, a phase of power needed at the location, and power generating resources at the location (e.g., external generators 114, buildings 116, etc.). For example, the power requirement may specify a street address (e.g., “29 Calle Washington”) or coordinates (e.g., “18.456045, −66.065469”). In some examples, the computing device 302 is integrated into the vehicle 100 and 102.

The power management server 304 coordinates the vehicles 100 and 102 in response to the request from the computing device 302. From time to time (e.g., periodically, in response to a request, etc.), the power management server 304 polls the vehicles 100 and 102 to determine the power characteristics (e.g., whether the vehicle is a primary vehicle 100 or a secondary vehicle 102, the phases of power the vehicle can generator, the current fuel level of the vehicle, etc.) The power management server 304 may be, for example, operated by a vehicle fleet manager, a construction company, or an emergency manager agency. The power management server 304 selects one or more of the vehicles 100 and 102 to respond to the request. The selection is based on several factors, including distance between the location associated with the power requirement and the vehicles 100 and 102, the fuel level of the vehicles 100 and 102, and/or the type of power the vehicles 100 and 102 are able to generate, etc. For example, the power management server 304 may exclude vehicles 100 and 102 that have fuel levels that indicate that the vehicle 100 and 102 cannot generate power for at least a threshold period of time. Additionally, in some examples, the power management server 304 uses other sources of information when selecting which vehicles 100 and 102 to response to the request. For example, the power management server 304 may use weather data (e.g., will a vehicle need four-wheel drive to reach the location?) and/or traffic data (e.g., making a travel time determination instead of a distance determination), etc. In some examples, at least one of the selected vehicles 100 and 102 is a primary vehicle 100. After selecting which vehicle(s) 100 and 102 are to respond to the request, the power management server 304 sends instructions to the selected vehicle(s) 100 and 102. In some examples, when the selected vehicle 100 and 102 is autonomous or unmanned, the instruction causes the selected vehicle 100 to autonomously navigate to the location. In some examples, the power management server 304 monitors the location(s) of the selected vehicle(s) 100 and 102 after sending the instructions. If the selected vehicle(s) 100 and 102 do(es) not arrive within a threshold period of time (or, based on updated traffic information, are not likely to arrive within the threshold period of time), the power management server 304 selects a different vehicle 100 and 102.

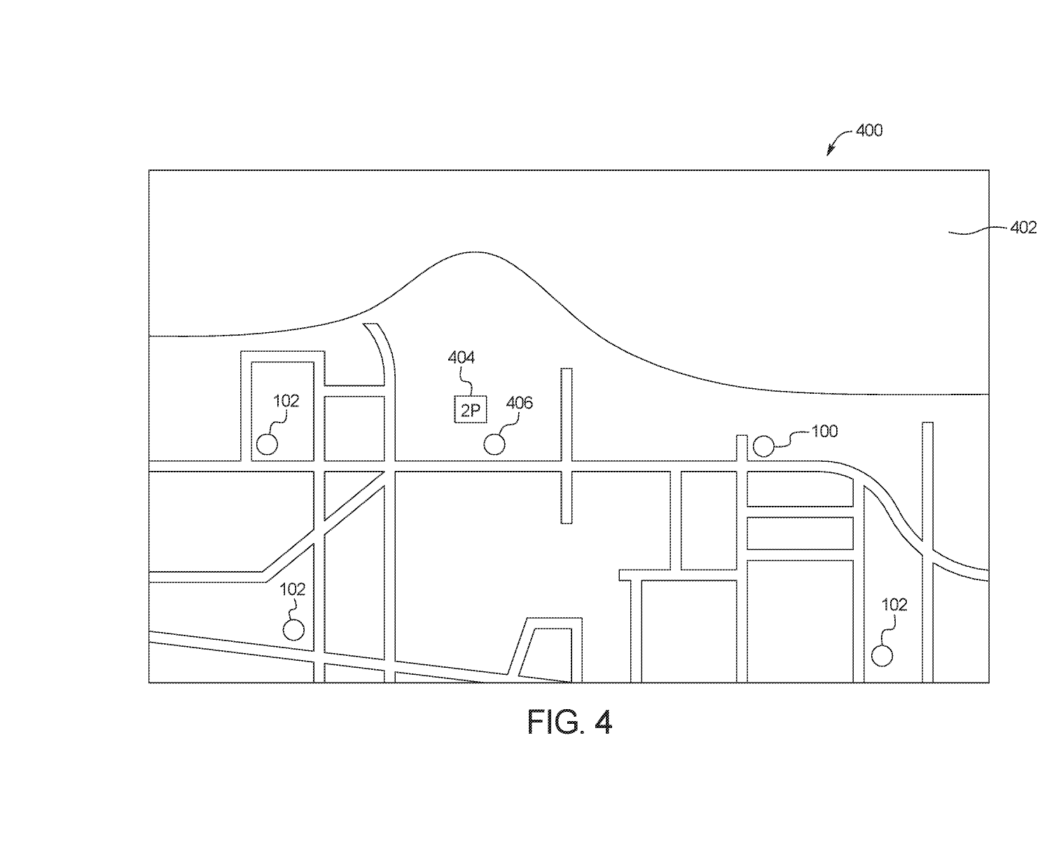

FIG. 4 illustrates an interface 400 to coordinate the vehicles 100 and 102 of FIGS. 1A, 1B, and 1C to provide multi-phase power. The interface 400 is provided by the power management server 304 to the computing device 302 of FIG. 3. In the illustrated example, the interface depicts a map 402 and a location 404 of a power requirement. The map 402 also depicts power generating sources 406 at the location 404, the location(s) 408 of primary vehicle(s) 100, and the location(s) of secondary vehicles 102. In some examples, the map 402 also depicts other information, such as traffic density, weather, and/or fuel levels of the vehicles 100 and 102, etc.

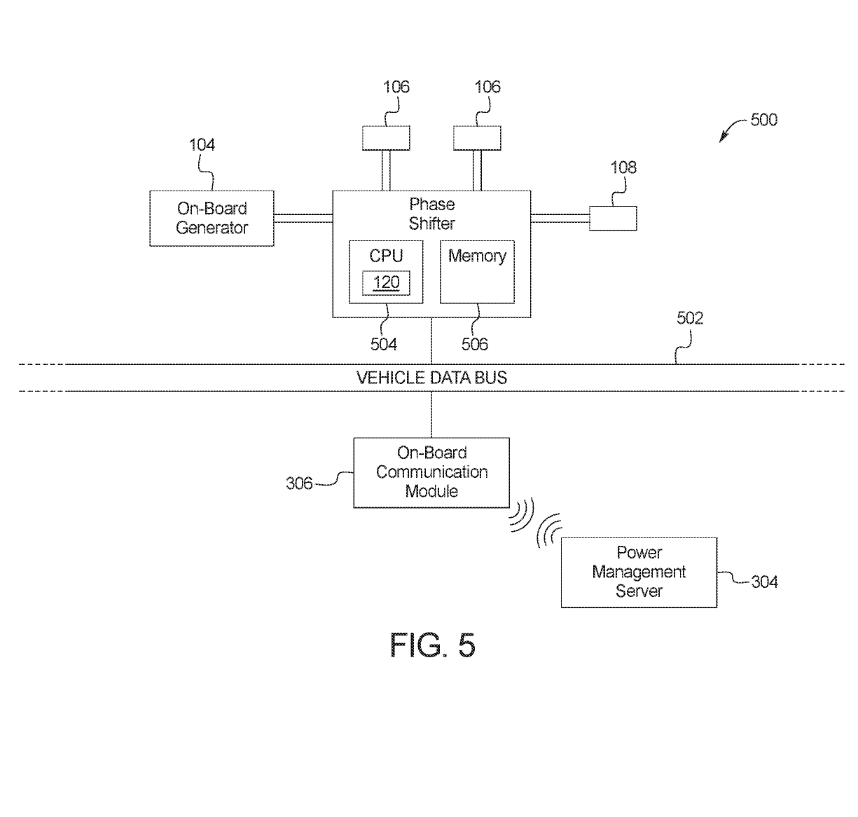

FIG. 5 is a block diagram of electronic components 500 of the primary vehicles 100 of FIGS. 1A, 1B, and 1C. In the illustrated example, the primary vehicle 100 includes the generator 104, the input connectors 106, the output connector 108, the phase converter 110, the on-board communication module 306, and a vehicle data bus 502.

In the illustrated examples, the phase converter 110 includes a processor or controller 504 and memory 506. In the illustrated example, the phase converter 110 is structured to include phase selector 120. The processor or controller 504 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 506 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc). In some examples, the memory 506 includes multiple kinds of memory, particularly volatile memory and non-volatile memory.

The memory 506 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 506, the computer readable medium, and/or within the processor 504 during execution of the instructions.

The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that is capable of storing, encoding or carrying a set of instructions for execution by a processor or that cause a system to perform any one or more of the methods or operations disclosed herein. As used herein, the term “tangible computer readable medium” is expressly defined to include any type of computer readable storage device and/or storage disk and to exclude propagating signals.

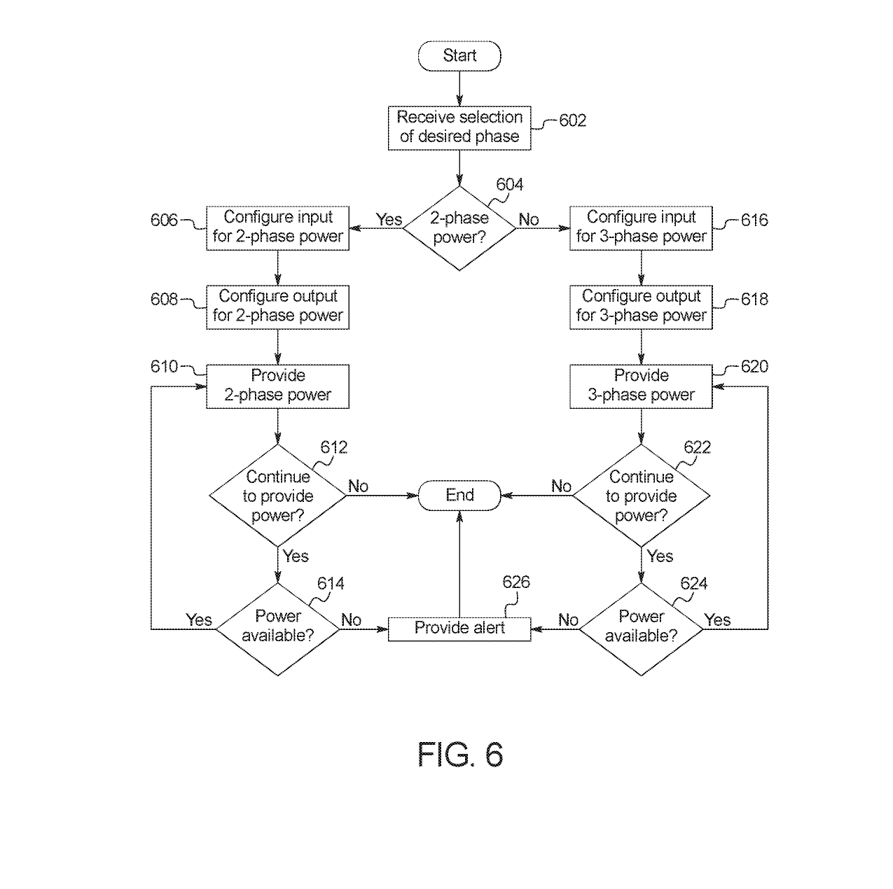

FIG. 6 is a flowchart of a method to provide multi-phase power, which may be implemented by the electronic components 500 of FIG. 5. Initially, at block 602, the phase selector 120 receives a selection of a desired type of power. In some examples, the selection is received via controls (e.g., a touch screen on the center console, button/switches, etc.) in the cabin of the primary vehicle 100. In some examples, the phase selector 120 determines the desired type of power based on the power cords 112 that are plugged into the input connectors 106. Alternatively, in some examples, the phase selector 120 receives a selection of the desired power from the power management server 304 via the on-board communication module 306. At block 604, the phase selector 120 determines whether the selection is for two-phase power. When the selection is for two-phase power, the method continues at block 606. Otherwise, when the selection is for three-phase power, the method continues at block 616.

At block 606, the phase selector 120 configures the input to the phase converter 110 for two-phase power generation. For example, the phase selector 102 may activate a relay that aligns the input connector 106 with the corresponding input into the phase converter 110. At block 608, the phase selector 120 configures the output of the phase converter 110 for two-phase power generation. In some examples, the phase selector 120 matches the output of the phase converter 110 to a corresponding one of the output connectors 108. Alternatively, the phase selector 120 configures the pins/sockets of the output connector 108 to correspond with two-phase power generation. At block 610, the phase converter 110 generates two-phase power. At block 612, the phase selector 120 determines whether to continue to provide power. For example, the operator may provide an input indicating to stop power generation of the phase selector 120 may receive instructions from the power management server 304 to stop power generation. When the power generation is not to continue, the method ends. Otherwise, when the power generation is to continue, the method continues at block 614. At block 614, The phase selector 120 determines whether power is available. In some examples, the phase selector 120 determines whether power is available based on whether the current fuel level of the primary vehicle 100 is greater than a fuel threshold that is greater than zero. In some such examples, the fuel threshold is established to provide fuel for the primary vehicle 100 to be able to travel a distance (e.g., to travel to a fuel station). In some examples, the phase selector 120 determines whether power is available based on whether power is being received via the input connectors 106. If power is available, the method returns to block 610. If power is not available, the method continues at block 626.

At block 616, the phase selector 120 configures the input to the phase converter 110 for three-phase power generation. For example, the phase selector 102 may activate a relay that aligns the input connector 106 with the corresponding input into the phase converter 110. At block 618, the phase selector 120 configures the output of the phase converter 110 for three-phase power generation. In some examples, the phase selector 120 matches the output of the phase converter 110 to a corresponding one of the output connectors 108. Alternatively, the phase selector 120 configures the pins/sockets of the output connector 108 to correspond with two-phase power generation. At block 620, the phase converter 110 generates three-phase power. At block 622, the phase selector 120 determines whether to continue to provide power. For example, the operator may provide an input indicating to stop power generation of the phase selector 120 may receive instructions from the power management server 304 to stop power generation. When the power generation is not to continue, the method ends. Otherwise, when the power generation is to continue, the method continues at block 624. At block 624, The phase selector 120 determines whether power is available. In some examples, the phase selector 120 determines whether power is available based on whether the current fuel level of the primary vehicle 100 is greater than a fuel threshold that is greater than zero. In some such examples, the fuel threshold is established to provide fuel for the primary vehicle 100 to be able to travel a distance (e.g., to travel to a fuel station). In some examples, the phase selector 120 determines whether power is available based on whether power is being received via the input connectors 106. If power is available, the method returns to block 620. If power is not available, the method continues at block 626.

At block 626, the phase selector 120 provides an alert. In some examples, the phase selector 120 provides an audio and/or visual alert via the primary vehicle 100 (e.g., via the head lights, the horn, etc.). In some examples, phase selector 120 sends the alert to the power management server 304.

The flowchart of FIG. 6 is representative of machine readable instructions stored in memory (such as the memory 506 of FIG. 5) that comprise one or more programs that, when executed by a processor (such as the processor 504 of FIG. 5), cause the vehicle 100 to implement the example phase selector 120 and/or, more generally, the phase converter 110 of FIGS. 1A, 1B, 1C, and 5. Further, although the example program(s) is/are described with reference to the flowchart illustrated in FIG. 6, many other methods of implementing the example phase selector 120 and/or, more generally, the phase converter 110 may alternatively be used. For example, the order of execution of the blocks may be changed, and/or some of the blocks described may be changed, eliminated, or combined.

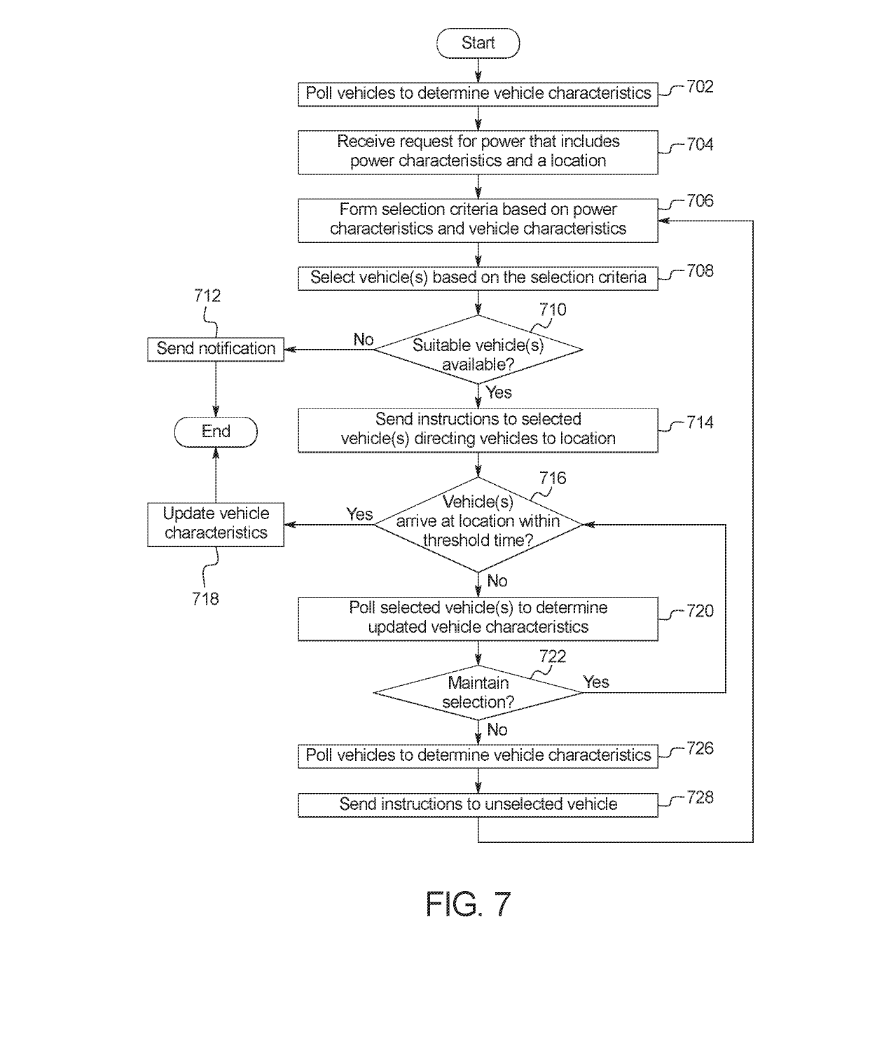

FIG. 7 is a flowchart of a method to coordinate and manage provision of multi-phase power by multiple vehicles 100 and 102, which may be implemented by the power management server 304 of FIGS. 3 and 5. Initially, at block 702, the power management server 304 polls the vehicle 100 and 102 to determine vehicle characteristics. At block 704, the power management server 304 receives a request for power that includes power characteristics (e.g., type of phase, duration required, etc.) and a location. At block 706, the power management server 304 forms selection criteria based on the power characteristics and the vehicle characteristics for determine which vehicles 100 and 102 are eligible to be selected. For example, the selection criteria may exclude vehicles 100 and 102 that are farther than a threshold distance or have a current fuel level that is estimated not to last the duration requirement. In some examples, when one of the vehicles 100 and 102 otherwise meets the selection criteria but does not have enough fuel for the expected duration of the power requirement, the power management server 304 still selects the vehicle 100 and 102 and directs the vehicle 100 and 102 to refuel before proceeding to the location 404. For example, when the selected vehicle 100 and 102 is a non-autonomous or semi-autonomous vehicle, the power management server 304 may send a notification directing the driver to refuel. As another example, when the selected vehicle 100 and 102 is autonomous, the power management server 304 may direct the selected vehicle 100 and 102 to autonomously travel to a refueling station reroute to the location 404. At block 708, the power management server 304 selects one or more of the vehicle 100 and 102. In some examples, at least one of the selected vehicles is a primary vehicle 100.

At block 710, the power management server 304 determines if the vehicle(s) 100 and 102 selected at block 710 are suitable to meet the requirements of the request. For example, there may not be enough vehicles 100 and 102 within range to provide the required power or a primary vehicle 100 may not be in range. If the vehicles 100 and 102 selected are not suitable, the method continues to block 712. Otherwise, if the selected vehicles 100 and 102 are suitable, the method continues at block 714. At block 712, the power management server 304 sends a notification to the requester indicating that the request cannot be fulfilled.

At block 714, the power management server 304 instructs the selected vehicle(s) 100 and 102 to proceed to the location 404 of the power request. At block 716, the power management server 304 determines whether the selected vehicles 100 and 102 arrive at the location within a threshold time. When the selected vehicles 100 and 102 arrive at the location within the threshold time, the method continues at block 718. Otherwise, when the selected vehicles 100 and 102 do not arrive at the location within the threshold time, the method continues at block 720. At block 718, the power management server 304 polls the vehicles 100 and 102 to update the vehicle characteristics.

At block 720, the power management server 304 polls the vehicles 100 and 102 to determine updated vehicle characteristics. At block 722, the power management server 304 determines whether to maintain the previous selection. For example, since the selection more vehicles 100 and 102 may have moved into range or previously considered vehicles 100 and 102 may have refueled. If the selection is maintained, the method returns to block 718. Otherwise, if the selection is not to be maintained, the method continues at block 724. At block 724, the power management server 304 sends a message to the unselected vehicle(s) 100 and 102. At block 726, the power management server 304 polls the vehicles 100 and 102 to determines vehicle characteristics. The method then returns to block 706.

The flowchart of FIG. 7 is representative of machine readable instructions stored in memory that comprise one or more programs that, when executed by a processor, implement the example power management server 304 of FIGS. 3 and 5. Further, although the example program(s) is/are described with reference to the flowchart illustrated in FIG. 7, many other methods of implementing the example power management server 304 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. As used here, the terms “module” and “unit” refer to hardware with circuitry to provide communication, control and/or monitoring capabilities, often in conjunction with sensors. “Modules” and “units” may also include firmware that executes on the circuitry. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

1-10. (canceled)

11. A method comprising:
periodically requesting, by a server, vehicle characteristics from first vehicles and second vehicles, each of the first vehicles including a generator and a phase converter, each of the second vehicles including the generator but not the phase converter;
in response to receiving a power request for supplying a load separate from the first vehicles and second vehicles:
selecting, by the server, at least one of the first vehicles;
responsive to determining that a first vehicle characteristic of said one of first vehicles does not satisfy the power request, additionally selecting, by the server, at least one of the second vehicles based on the first vehicle characteristic, a second vehicle characteristic of said one of the second vehicles, and the power request; and
instructing said one of the first vehicles and said one of the second vehicles to proceed to the location.

12. (canceled)

13. (canceled)

14. The method of claim 11, wherein the first and second vehicle characteristics include a location.

15. The method of claim 14, wherein the first and second vehicle characteristics include a fuel level.

16. (canceled)

17. The method of claim 11, wherein the first and second vehicles are autonomous, and wherein instructing said one of the first vehicles and said one of the second vehicles to proceed to a location associated with the power request causes said one of the first vehicles and said one of the second vehicles to autonomously navigate to the location.

18. The method of claim 11, wherein the power request includes a type of phase of power required to supply the load.

19. The method of claim 18, wherein selecting said one of the second vehicles includes selecting said one of the second vehicles based on whether said one of the first vehicles and said one of the second vehicles in combination support the type of phase of power required to supply the load.

20. The method of claim 11, wherein the selection among the first vehicle and the second vehicles is based at least in part on:
receiving, at the server, weather data;
based on the weather data, determining whether a predetermined weather is affecting a route from each of said one of the first vehicles and said one of the second vehicles to the location; and
determining whether each of said one of the first vehicles and said one of the second vehicles includes a vehicle feature for traveling in the predetermined weather.

21. The method of claim 20, wherein the vehicle feature is a four-wheel drive feature.

22. The method of claim 11, wherein the selection among the first vehicles and the second vehicles is based at least in part on whether a travel time of each of said one of the first vehicles and said one of the second vehicles to the location satisfies a threshold time.
